(19) United States
(12) Patent Application Publication
(10) Pub. No.: US 2009/0086963 A1
(43) Pub. Date: Apr. 2, 2009

(54) Systems and Methods for Protecting the Anonymity of Entities

(75) Inventor: Jonathan M. Dugan, Palo Alto, CA (US)

Correspondence Address: Giorgos A. Georgakis;Chowdhury & Georgakis, PC, PO BOX 90277, AUSTIN, TX, 78709-0277, US

(73) Assignee: MATSON SYSTEMS, INC., Palo Alto, CA (US)

(21) Appl. No.: 11/864,682

(22) Filed: Sep. 28, 2007

(51) Int. Cl. H04L 9/06

(52) U.S. Cl. 380/29

(57) ABSTRACT

Systems and methods for protecting the anonymity of one or more entities comprising personalizing a reference associated with information about an entity using one or more codes associated with a viewing entity to generate a personalized reference with which to present the information to the viewing entity.

### I. BACKGROUND

The invention relates generally to the field of protecting the anonymity of one or more entities.

Anonymity may be defined as a measure of how an entity (a person, for example) can be identified from within a larger group. Information that is known about the entity can reduce the entity's anonymity. Additional information that is known about the entity can reduce the entity's anonymity further. In certain situations, information related to an entity needs to be disclosed, online or otherwise, thereby potentially reducing the entity's anonymity.

### II. SUMMARY

In one respect, disclosed is a method for protecting the anonymity of one or more entities, the method comprising personalizing a reference associated with information about an entity using one or more codes associated with a viewing entity to generate a personalized reference with which to present the information to the viewing entity.

In another respect, disclosed is an information handling system, the system comprising: one or more processors; one or more memory units; and one or more communication devices, the system being configured to personalize a reference associated with information about an entity using one or more codes associated with a viewing entity to generate a personalized reference with which to present the information to the viewing entity.

In yet another respect, a computer program product stored on a computer operable medium, the computer program product comprising software code being effective to: personalize a reference associated with information about an entity using one or more codes associated with a viewing entity to generate a personalized reference with which to present the information to the viewing entity.

Numerous additional embodiments are also possible.

### III. BRIEF DESCRIPTION OF THE DRAWINGS

Other objects and advantages of the invention may become apparent upon reading the detailed description and upon referring to the accompanying drawings.

FIG. 1 is a flow diagram illustrating a method for protecting the anonymity of one or more entities by personalizing references to information about the entities, in accordance with one embodiment.

FIG. 2 is a flow diagram illustrating a method for hashing an identifier of an entity to present to another entity, in accordance with one embodiment.

FIG. 3 is a flow diagram illustrating a method for hashing an identifier of an entity and an identifier of a post by the entity to present to a viewing entity, in accordance with one embodiment.

FIG. 4 is a flow diagram illustrating a method for hashing an identifier of an entity and an identifier of a post by the entity using one or more secret codes and one or more other secret codes associated with the information and presenting the hashed identifier of the entity and the hashed identifier of the post to a viewing entity, in accordance with one embodiment.

FIG. 5 is a block diagram illustrating an example of presenting a first hashed identifier of a person to a first viewing person and a second hashed identifier of the person to a second viewing person, in accordance with one embodiment.

FIG. 6 is a block diagram illustrating an example of presenting a first hashed identifier of a person and a first hashed identifier of the person's post to a first person and a second hashed identifier of the person and a second hashed identifier of the person's post to a second person, in accordance with one embodiment.

FIG. 7 is a block diagram illustrating an alternative example of presenting a first hashed identifier of a person and a first hashed identifier of the person's post to a first person and a second hashed identifier of the person and a second hashed identifier of the person's post to a second person, in accordance with one embodiment.

FIG. 8 is a block diagram illustrating a system configured to perform the methods disclosed herein, in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

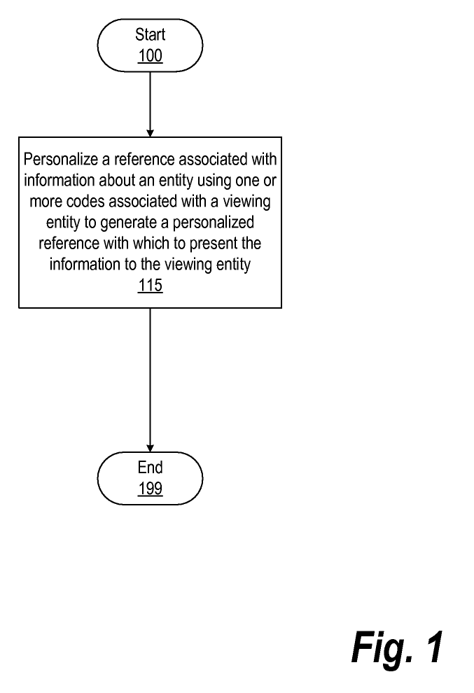

FIG. 1 is a flow diagram illustrating a method for protecting the anonymity of one or more entities by personalizing references to information about the entities, in accordance with one embodiment.

Processing begins at 100 whereupon, at block 115, a reference associated with information about an entity is personalized for a viewing entity using one or more codes associated with the viewing entity. The information is then presented to the viewing entity using the personalized reference.

Processing subsequently ends at 199.

In one embodiment, the reference may also be personalized for another viewing entity by using one or more codes associated with the other viewing entity. The information may then be presented to the other viewing entity using the other personalized reference, such that the entity and the other entity may receive the same information using two different references. By presenting different references to different viewing entities, the viewing entities may not combine references and information and thereby reduce the anonymity of the entity.

In one embodiment, the reference may be anything that points to the information and/or anything that enables the viewing entities to access the information. The reference may be, for example, a URL or other address that points to the information. In one embodiment, as described above, different URLs pointing to the same information may be presented to different entities. In one embodiment, the reference may be a simple identifier identifying the entity (or other information about the entity) to the viewing entities. Again, different viewing entities may be presented with different entity identifiers.

In one embodiment, personalizing the references comprises hashing each reference with one or more codes associated with the viewing entity to generate a personalized reference to be presented to the viewing entity. In one embodiment, the one or more codes used are unknown to the viewing entity to prevent the viewing entity from reversing the hashing algorithm and obtaining the internal reference to the information. In one embodiment, the hashing is bidirectional such that those entities with access to the one or more secret codes can reverse the hashing algorithms and obtain the internal reference to the information.

In an embodiment where the reference is a URL, for example, the internal URL pointing to information about an entity is first hashed and then provided to a viewing entity. The URL may be hashed using one or more secret codes associated with but unknown to the viewing entity. The viewing entity may then present the hashed URL when the viewing entity wishes to access the information to which the internal URL points. Using the provided hashed URL and the one or more secret codes associated with the viewing entity, the hashing is reversed in order to obtain the internal URL and provide the information to the viewing entity. In one embodiment, the internal URL is not provided to the viewing entity; only the hashed URL is provided.

In one embodiment, any suitable hashing algorithm or similar process may be used to personalize the reference. Representative algorithms are given, for example, in chapter 12 of the book: “Introduction to Algorithms” (MIT Electrical Engineering and Computer Science) by Thomas H. Cormen, Charles E. Leiserson, Ronald L. Rivest.

In one embodiment, the hashing can be bidirectional with “open addressing” (no external hash table) and “linear probing” (using addition to reach the desired address). In other embodiments, the hashing can be implemented with any hashing scheme that allows reverse lookups. In yet other embodiments, a more complex hash function may be used such as an md5 hash where an additional hash table may be maintained for the decoding.

Information can be anything that, in the hands of a viewing entity, can reduce the anonymity of an entity. Examples include: reputation or transaction history of the entity, location, age, gender, username, or other identifying information of the entity, posts, text, audio or video generated by the entity, a recorded action, preference or desire of the entity, a resource or item of value owned by the entity, connections and relationships between the entity and other entities.

In one embodiment, an entity is a person whose anonymity is to be protected. An entity can also be a group of persons, a company, an organization, etc. Similarly, a viewing entity can also be a person, a group of persons, a company, an organization, etc.

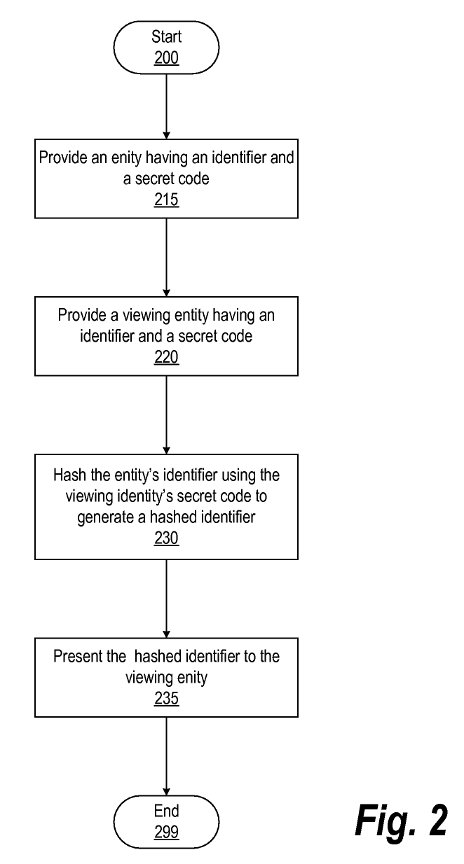

FIG. 2 is a flow diagram illustrating a method for hashing an identifier of an entity to present to another entity, in accordance with one embodiment.

Processing begins at 200 whereupon, at block 215, an entity is provided having an identifier and a secret code. In one embodiment, a minimum amount of information about the entity is to be disclosed to a viewing entity in order to protect the anonymity of the entity.

At block 220, a viewing entity is provided having an identifier and a secret code. In one embodiment, the secret code is unknown to the viewing entity. At block 230, the entity's identifier is hashed using the viewing identity's secret code, generating a hashed identifier for the entity. Various hashing methods may be used as described above.

At block 235, the hashed identifier is presented to the viewing entity. In one embodiment, the hashed identifier is presented to the viewing entity in order to hide the entity's internal identifier from the viewing identity. In an embodiment where the secret code is unknown to the viewing entity, it would be extremely difficult for the viewing entity to invert the hashing algorithm and to determine the internal identity of the entity.

In one embodiment, the process may be repeated for another viewing entity having another secret code. In that embodiment, the identifier is hashed using the other entity's secret code, thus resulting in another hashed identifier. That is, a different hashed identifier may be presented to different viewing entities. Thus, the two viewing entities, being presented with different hashed identifiers, cannot determine that their hashed identifiers point to the same entity.

Processing subsequently ends at 299.

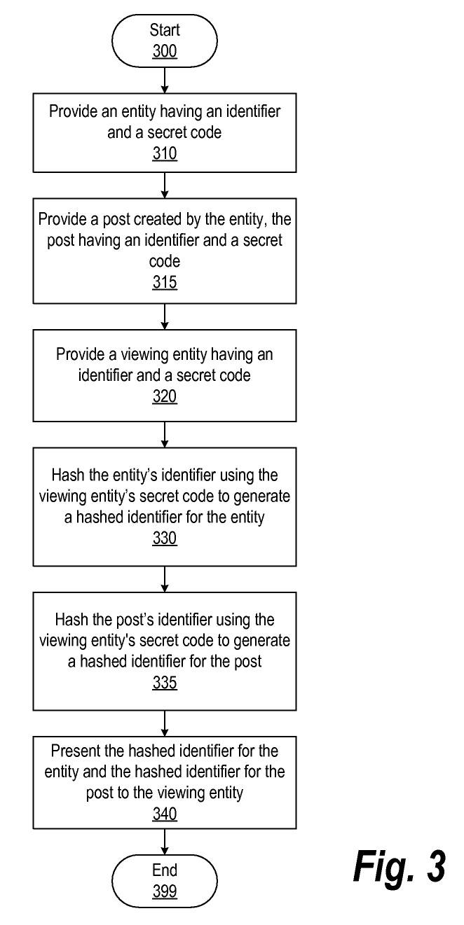

FIG. 3 is a flow diagram illustrating a method for hashing an identifier of an entity and an identifier of a post by the entity to present to a viewing entity, in accordance with one embodiment.

Processing begins at 300 whereupon, at block 310, an entity is provided having an identifier and a secret code. At block 315, a post is created by the entity, the post having a post identifier and a post secret code. The post may be, for example, a message that the entity posts on a bulletin board on the Internet. At block 320, a viewing entity is provided having an identifier and a secret code.

It should be noted that post may be or refer to any information generated by or associated with the entity that is made accessible to one or more viewing entities. Examples include text written, copied, or posted on a bulletin board or website, e-mails, audio and video recordings, survey, forms results, or logs or their behavior, etc.

At block 330, the entity's identifier is hashed using the viewing entity's secret code to generate a hashed identifier for the entity. At block 335, the post's identifier is hashed using the viewing entity's secret code to generate a hashed identifier for the post. Various hashing algorithms may be used as described above.

At block 340, the hashed entity's identifier and the hashed post's identifier are presented to the viewing entity. In one embodiment, the internal identifier for the entity and the internal identifier for the post are not presented to the viewing entity in order to protect the anonymity of the entity. In one embodiment, the viewing entity's secret code is unknown to the viewing entity in order to prevent the viewing entity from obtaining the internal identifier for the entity and the internal identifier for the post.

Processing subsequently ends at 399.

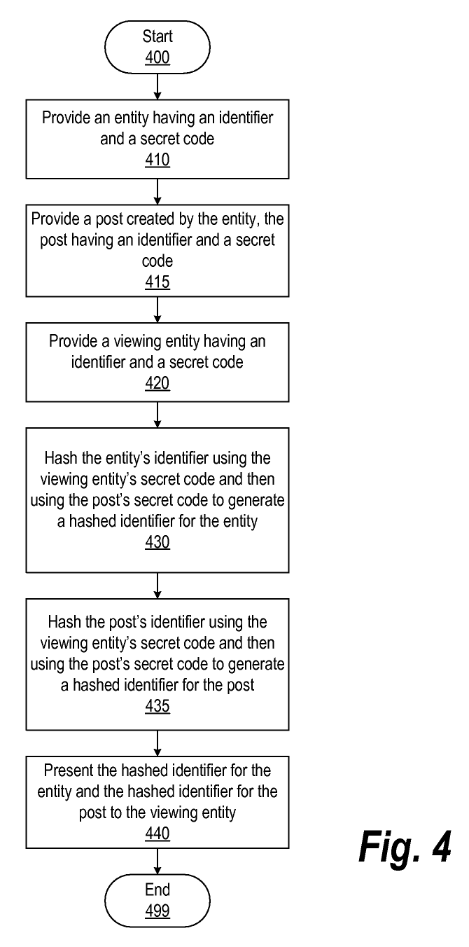

FIG. 4 is a flow diagram illustrating a method for hashing an identifier of an entity and an identifier of a post by the entity using one or more secret codes and one or more other secret codes associated with the information and presenting the hashed identifier of the entity and the hashed identifier of the post to a viewing entity, in accordance with one embodiment.

Processing begins at 410 whereupon, at block 410, an entity is provided having an identifier and a secret code. At block 415, a post created by the entity is provided, the post having an identifier and a secret code. At block 420, a viewing entity is provided having an identifier and a secret code.

At block 430, the entity's identifier is hashed using the viewing entity's secret code and the post's secret code. Hashing the entity's identifier using the post's secret code in addition to the viewing entity's secret code ensures that the viewing entity is provided with a different identifier corresponding to each post that the viewing entity is viewing. At block 435, the post's identifier is hashed using the viewing entity's secret code and the post's secret code.

At block 440, the hashed identifier for the entity and the hashed identifier of the post are presented to the viewing entity.

Processing subsequently ends at 499.

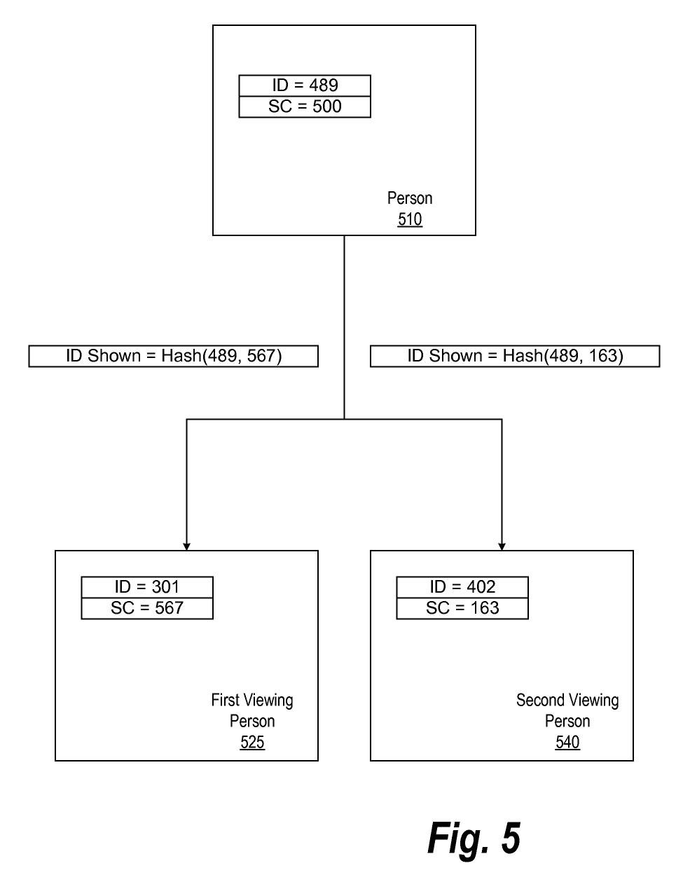

FIG. 5 is a block diagram illustrating an example of presenting a first hashed identifier of a person to a first viewing person and a second hashed identifier of the person to a second viewing person, in accordance with one embodiment.

Person 510 has an identifier and a secret code, and so do first viewing person 525 and second viewing person 540. In the example shown, an identifier for person 510 is to be presented to the viewing persons. Since the anonymity of Person 510 is to be protected, a hashed identifier is computed and presented to the viewing persons in place of the actual identifier. In one embodiment, the secret code of each viewing person is used to hash the identifier for that viewing person. The secret code of each person may be kept secret from each viewing person in order to prevent the viewing persons from being able to easily determine the internal identifier of the person.

It should be noted that in this description a person is used as one example of an entity whose identity is to be protected.

As shown in the example, in order to form the hashed identifier to be presented to the first viewing person, the person's identifier (489) is hashed with the first viewing person's secret code (567). In order to form the hashed identifier to be presented to the second viewing person, the person's identifier (489) is hashed with the second viewing person's secret code (163). Various hashing algorithms may be used as described above.

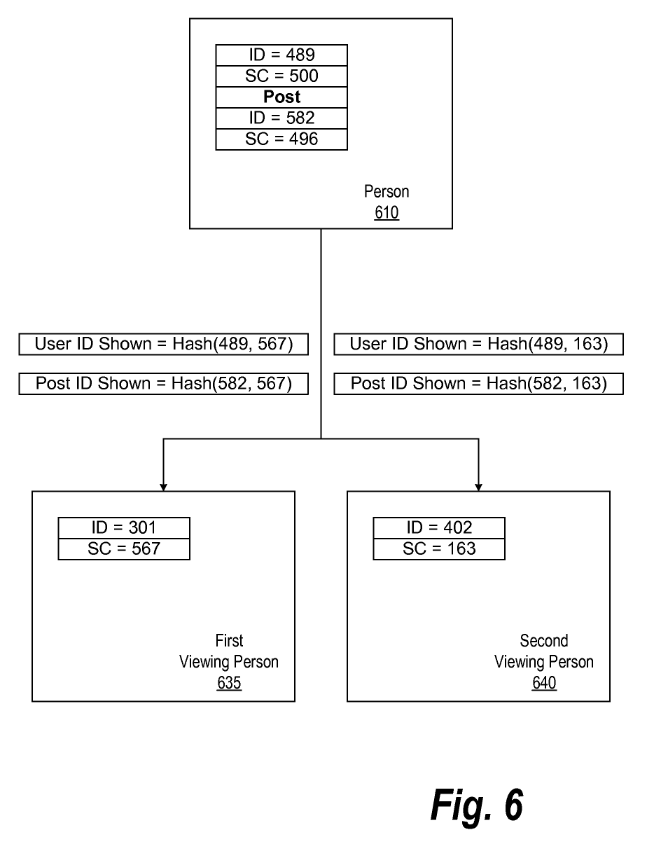

FIG. 6 is a block diagram illustrating an example of presenting a first hashed identifier of a person and a first hashed identifier of the person's post to a first person and a second hashed identifier of the person and a second hashed identifier of the person's post to a second person, in accordance with one embodiment.

In one embodiment, the anonymity of person 610 is to be protected. That is, limited information about the person is to be presented to viewing person 635 and viewing person 640 by using a personalized identifier for person 610 and a personal identifier for the person's posts.

It should be noted that in this description a person is used as one example of an entity whose identity is to be protected.

Person 610, who has an identifier and a secret code, may post a message on a bulletin board, for example. The post has its own unique identifier and secret code. The person's identifier and the identifier of the post are to be presented to various other viewing persons. For example, the post's identifier may be used in a URL pointing to the post and the person's identifier may be included in that post.

In one embodiment, the identifier of person 610 and the post's identifier are to be hashed and presented to first viewing person 635. Similarly, the identifier of person 610 and the post's identifier are to be hashed and presented to second viewing person 640.

The first hashed identifier may be formed, for example, by hashing the person's identifier (489) using the secret code of first viewing person (567). The first hashed identifier may then be presented to first viewing person 635.

The second hashed identifier similarly may be formed, for example, by hashing the person's identifier (489) using the secret code of second viewing person (163). The second hashed identifier may then be presented to second viewing person 640.

The first hashed identifier for the post may be formed, for example, by hashing the post's identifier (582) using the secret code of first viewing person (567). The first hashed identifier for the post may then be presented to first viewing person 635.

The second hashed identifier for the post similarly may be formed, for example, by hashing the post's identifier (582) using the secret code of second viewing person (163). The second hashed identifier for the post may then be presented to second viewing person 635.

A different hashed identifier for the person and a different hashed identifier for the post are presented to each of the viewing persons. Thus, the anonymity of the person is protected since the viewing persons cannot determine the internal identifier for the person and for the post.

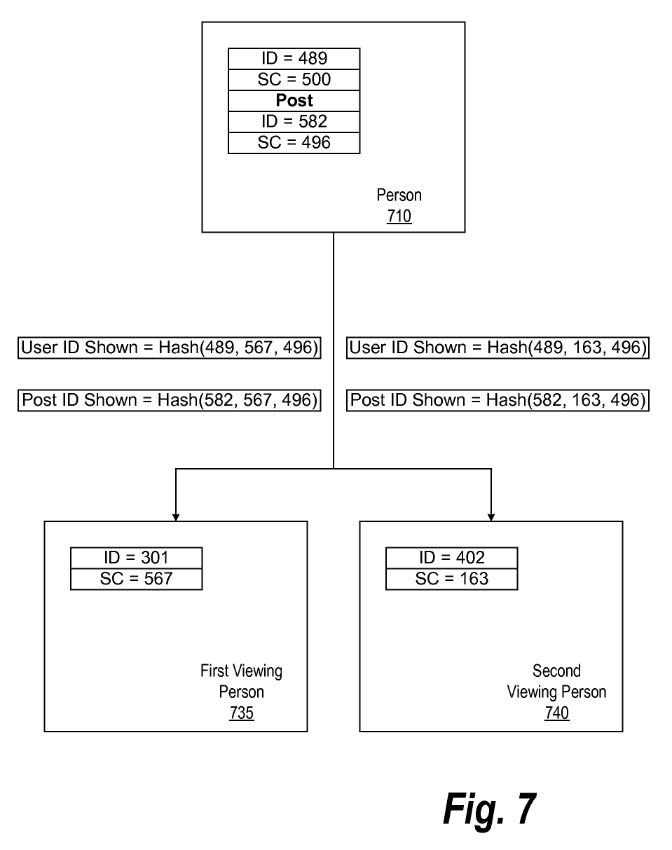

FIG. 7 is a block diagram illustrating an alternative example of presenting a first hashed identifier of a person and a first hashed identifier of the person's post to a first person and a second hashed identifier of the person and a second hashed identifier of the person's post to a second person, in accordance with one embodiment.

In one embodiment, the anonymity of person 710 is to be protected. That is, limited information about the person is to be presented to viewing person 735 and viewing person 740 by using personalized identifiers for person 710 and/or personalized identifiers for the person's posts.

It should be noted that in this description a person is used as one example of an entity whose identity is to be protected.

Person 710, who has an identifier and a secret code, may post a message on a bulletin board, for example. The post has its own unique identifier and secret code. The person's identifier and the identifier of the post are to be presented to various other viewing persons. For example, the post's identifier may be used in a URL pointing to the post and the person's identifier may be included in that post.

In one embodiment, the identifier of person 710 and the post's identifier are to be hashed and presented to first viewing person 735. Similarly, the identifier of person 710 and the post's identifier are to be hashed and presented to second viewing person 740.

The first hashed identifier may be formed, for example, by hashing the person's identifier (489) using the secret code of first viewing person (567) and then with the post's secret code (496). The first hashed identifier may then be presented to first viewing person 735.

The second hashed identifier similarly may be formed, for example, by hashing the person's identifier (489) using the secret code of second viewing person (163) and then with the post's secret code (496). The second hashed identifier may then be presented to second viewing person 740.

The first hashed identifier for the post may be formed, for example, by hashing the post's identifier (582) using the secret code of first viewing person (567) and then with the post's secret code (496). The first hashed identifier for the post may then be presented to first viewing person 735.

The second hashed identifier for the post similarly may be formed, for example, by hashing the post's identifier (582) using the secret code of second viewing person (163) and then with the post's secret code (496). The second hashed identifier for the post may then be presented to second viewing person 735.

A different hashed identifier for the person and a different hashed identifier for the post are presented to each of the viewing persons. Thus, the anonymity of the person is protected since the viewing persons cannot determine the internal identifier for the person and for the post.

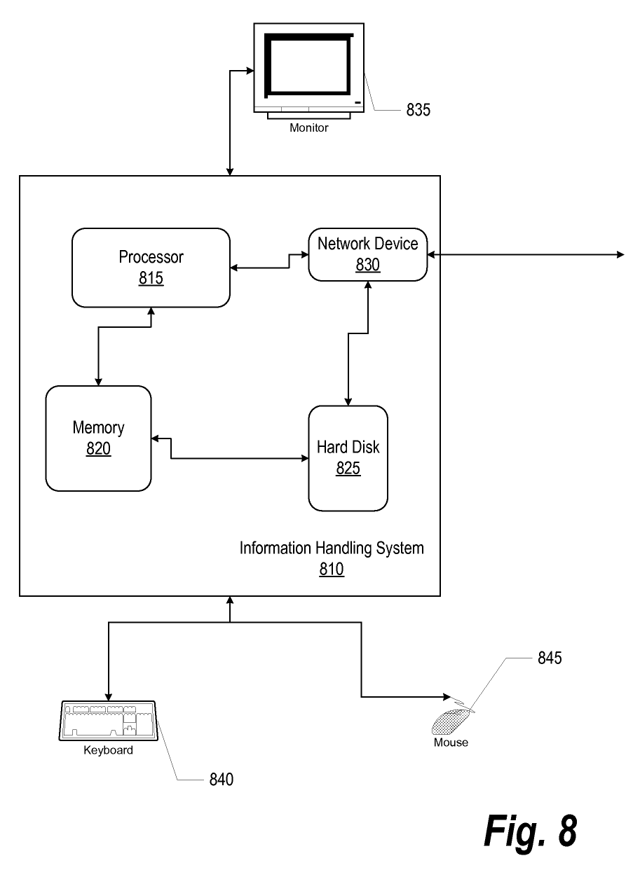

FIG. 8 is a block diagram illustrating a system configured to perform the methods disclosed herein, in accordance with one embodiment.

FIG. 8 is a block diagram illustrating a system configured to enable a client to communicate with a host, in accordance with one embodiment. Information handling system 810 may include software or hardware or both and is configured to perform the function(s) claimed in this application. In the example shown in the figure, the information handling system includes memory 820, processor 815, hard disk 825, input/output/network unit 830, keyboard 840, pointing device 845, and display monitor 835. Other configurations of the information handling system are possible.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for protecting the anonymity of one or more entities, the method comprising personalizing a reference associated with information about an entity using one or more codes associated with a viewing entity to generate a personalized reference with which to present the information to the viewing entity.

2. The method of claim 1, wherein the one or more codes are unknown to the viewing entity.

3. The method of claim 1, wherein the reference is at least one of: a URL, an address, a pointer, and an identifier.

4. The method of claim 1, wherein the personalizing comprises hashing the reference using the one or more codes.

5. The method of claim 4, wherein the hashing comprises hashing the reference using the one or more codes and one or more information-associated codes.

6. The method of claim 4, wherein the entity and the viewing entity are at least one of: a person, a group of persons, and an organization.

7. The method of claim 4, wherein the hashing is bidirectional.

8. An information handling system, the system comprising:
one or more processors;
one or more memory units; and
one or more communication devices,
the system being configured to personalize a reference associated with information about an entity using one or more codes associated with a viewing entity to generate a personalized reference with which to present the information to the viewing entity.

9. The system of claim 7, wherein the one or more codes are unknown to the viewing entity.

10. The system of claim 7, wherein the reference is at least one of: a URL, an address, a pointer, and an identifier.

11. The system of claim 7, wherein the system being configured to personalize comprises the system being configured to hash the reference using the one or more codes.

12. The system of claim 11, wherein the system being configured to hash comprises the system being configured to hash the reference using the one or more codes and one or more information-associated codes.

13. The system of claim 11, wherein the entity and the viewing entity are at least one of:
a person, a group of persons, and an organization.

14. The system of claim 11, wherein the hashing is bidirectional.

15. A computer program product stored on a computer operable medium, the computer program product comprising software code being effective to: personalize a reference associated with information about an entity using one or more codes associated with a viewing entity to generate a personalized reference with which to present the information to the viewing entity.

16. The product of claim 15, wherein the one or more codes are unknown to the viewing entity.

17. The product of claim 15, wherein the reference is at least one of: a URL, an address, a pointer, and an identifier.

18. The product of claim 15, wherein the software code being configured to personalize comprises the software code being configured to hash the reference using the one or more codes.

19. The product of claim 18, wherein the software code being configured to hash comprises the software code being configured to hash the reference using the one or more codes and one or more information-associated codes.

20. The product of claim 18, wherein the entity and the viewing entity are at least one of:
a person, a group of persons, and an organization.

21. The product of claim 18, wherein the hashing is bidirectional.
